(19) United States
(12) Patent Application Publication
(10) Pub. No.: US 2006/0002643 A1
(43) Pub. Date: Jan. 5, 2006

(54) Bearing shell, bearing, and method for the production of bearing shells

(76) Inventor: Edwin Aubele, Taunusstein (DE)

Correspondence Address: Robert L Stearns;Howard & Howard Attorneys, 39400 Woodward Avenue, Suite 101, Bloomfield Hills, MI, 48304-5151, US

(21) Appl. No.: 10/533,102

(22) PCT Filed: Oct. 23, 2003
(86) PCT No.: PCT/DE03/03544

§ 371 Date: Apr. 28, 2005

(30) Foreign Application Priority Data
Oct. 30, 2002 (DE) 10250474.1

(51) Int. Cl. F16C 33/10

(52) U.S. Cl. 384/288

(57) ABSTRACT

Disclosed is a bearing shell comprising a metallic supporting material which is coated with at least one sliding bearing material. At least one oil-bearing groove is engraved within the rear side of the supporting materials. According to a method; a band made of composite material is produced by coating one side of a metallic supporting material with at least one sliding bearing material; grooves are engraved into the bare supporting material of the band; strips of material are cut and shaped into bearing shells; and the inside of the bearing shells is machined, resulting in material being removed.

The invention relates to a bearing shell having a backing material of metal, in particular of steel, which is coated at least with a plain bearing material. The invention also relates to the use of such bearing shells, to a bearing composed of such bearing shells and to a method of producing bearing shells.

Such bearing shells are in particular used in internal combustion engines, crankshaft bearings and connecting rod bearings. Depending on the manner in which oil is conveyed in the engine, these bearing shells may comprise oil holes, and oil grooves in the sliding surface, i.e. in the plain bearing material. These oil grooves are connected with the oil holes and are milled into the bearing material. Such oil grooves generally extend over the entire inner circumference of the bearing shells. Where oil grooves are arranged in the bearing backing, the bearing shells are large size bearing shells for marine diesel, wherein the oil grooves each extend over the entire bearing shell circumference.

Novel private car engine designs provide modified oil conveyance, the lubricating oil having in part to be conveyed around the bearing shell. Experiments with oil grooves in the bearing receptacle have proven complex and cost-intensive. A further disadvantage is that such grooves have to extend from the bearing housing as far as into the bearing cap, such that material weakening in the area between bearing housing and bearing cap leads to problems of stability. Furthermore, the space available is very small, due to the retaining screw located therein.

Plain bearing elements are known from DE 33 28 509 C1, which comprise fine channels in the bearing backing as drainage channels for liquid lubricant, which channels occupy a maximum of 15% of the contact surface. The depth is indicated as being 0.03 to 0.2 mm. This measure is intended to prevent carbon build-up between the rear face of the bearing and the receiving bore, without the machine parts accommodating the bearing and the elements holding the bearing bore together having to be of reinforced and thus of heavier construction. The lubricant penetrating between the seating faces may escape in the course of the relative movement towards the free ends of said seating faces. All drainage channels have accordingly to open at the axial end edges of the plain bearing element. These drainage channels are thus not suitable for purposeful oil guidance. No statement is made about the manner in which the drainage channels are produced.

It is therefore the object of the invention to provide a low-cost bearing shell, which allows oil to be conveyed at the rear of the bearing shell. It is also the object of the invention to provide a method of producing said bearing shells.

This object is achieved with a bearing shell in which at least one oil-conveying groove is stamped into the rear of the backing material.

It has been demonstrated that it is easier to introduce an oil-conveying groove into the backing material of the bearing shell than into the bearing receptacle, wherein at the same time weakening of the material in the area of transition between bearing housing and bearing cap is avoided. Weakening of the material of the bearing shell does not have any negative effects on the load-carrying capacity and service life of the bearing shell.

It has further been demonstrated that stamping of a groove into the metal backing of the bearing shell may be carried out much more cheaply than is possible using other methods, such as for example milling. Altogether, therefore, a bearing shell with external groove may be produced economically.

The groove preferably extends from a bearing shell end over part of the external circumference of the bearing shell. It is not necessary for these new engine designs for the groove to extend over the entire outer circumference of the bearing shell, because the oil feed and oil drainage channels in the bearing housing or the bearing cap are generally arranged in the area of the bearing shell vertex.

The groove preferably extends in the circumferential direction, i.e. parallel to the axial end faces of the bearing shell.

To make it possible to convey oil at the rear from one bearing shell to the other bearing shell in a bearing consisting of two bearing shells, the groove preferably opens into the parting face of the bearing shell.

The groove preferably extends over a circumferential angle of ? ? 120°, in particular over a circumferential angle of ? ? 90°, wherein this angle is calculated from the parting face.

The groove preferably exhibits its maximum depth Tₘₐₓ in the area of the parting face and the depth T reduces continuously along the groove until T=0. This means that the groove merges continuously with the outer surface of the bearing shell.

The depth Tₘₐₓ is preferably ? 0.8 D, wherein D denotes the thickness of the backing material. The depth and the width of the groove depend on the requirements relating to the quantity of oil to be conveyed, wherein, on the other hand, care must be taken to ensure that the bearing material is deformed only slightly during stamping in of the groove. This is described in more detail in relation to the method.

The plain bearing material preferably consists of an aluminum alloy, a sintered bronze or a cast bronze. Preferred materials are AlSn6, CuAl7, Cu80Sn10Pb10 or Cu80Sn10Zn10.

If necessary, at least one intermediate layer may be additionally provided between the backing and plain bearing material. An overlay on the plain bearing materialis also possible.

The bearing, which is constructed from two bearing shells according to the invention, provide for the two bearing shells to be arranged in such a way relative to one another that the parting faces, into which the grooves open, lie against one another.

The bearing shells are preferably used in the main bearing of an (internal) combustion engine.

The method of producing such bearing shells is characterized by the following method steps:
production of a strip of composite material by coating one side of a metallic backing material with at least one plain bearing material,
stamping of grooves into the bare backing material of the strip,
cutting off of portions of material,
shaping of the portions of material into bearing shells and
internal machining of the bearing shells, which is associated with removal of material.

It has been demonstrated that the stamping of grooves into the strip material may be incorporated into the conventional bearing shell production process, wherein it is merely necessary to accommodate a stamping station in the production sequence. In comparison with the machining of grooves, the stamping process is markedly quicker, such that the entire bearing shell production time is lengthened only insignificantly.

It has also been demonstrated that the disadvantageous effects of the inevitable material displacements arising on stamping may be simply removed in the subsequent operations. Stamping of the groove into a finished bearing shell would necessitate additional, complex post-machining.

Portions of material are cut off along parting lines extending perpendicularly to the strip feed direction, wherein, depending on the strip width, the portions of material extend perpendicularly to the feed direction or parallel thereto. In the latter case, the strip width corresponds to the width of the cut-off material portion.

Machining of the edges of the material portions may take place before or after shaping.

The grooves are stamped in with their longitudinal axes preferably perpendicular to the strip feed direction, which is in accordance with one of the conventional operations carried out during the production of bearing shells provided that the material portions cut off successively from the strip material and subsequently shaped into bearing shells extend perpendicularly to the strip feed direction. If the material portions extend in the feed direction, the grooves are accordingly also stamped with their longitudinal axes in the feed direction.

Grooves are preferably stamped in with a continuously decreasing groove depth.

The plain bearing material is preferably applied to the backing material with an elevated amount of surplus. The bearing material is reduced to its final thickness during internal machining of the bearing shell, for example by a drilling method.

Internal machining of the finished bearing shell is also provided with conventional production of bearing shells. However, this conventional internal machining merely requires application of the bearing material with a small amount of surplus.

However, it has emerged that, depending on the size of the groove, stamping may cause deformation of the bearing material, which cannot be completely eliminated with subsequent conventional internal machining. It has been demonstrated that elimination of this deformation is only completely successful if internal machining is accompanied by the removal of a correspondingly large amount of material. The bearing material has namely to be applied with an elevated amount of surplus, such that a considerable amount of material may be removed over the entire inner surface of the bearing shell, in order completely to eliminate the deformations in the bearing material, such that the sliding surface attains its optimum contour. An elevated amount of surplus is understood to be a surplus ? 0.2 mm, i.e. a material thickness which is ? 0.2 mm greater than the final dimension.

Stamping of grooves into the strip material leads to a widening and curvature of the strip in the strip plane due to the displacement of material. Since the conventional machining apparatus is designed for machining straight strips, it is advantageous for at least one compensating stamping to be introduced in each case on the opposite side of the strip from the groove.

This compensating stamping is performed in such a way that a comparable material displacement occurs in the strip plane as occurs on stamping in of the groove. On the other hand, it must be ensured that the stamping in of compensating grooves does not lead to high levels of material wastage if the area of the compensating grooves has to be cut away from the material.

It has therefore proven advantageous for the compensating stampings to be introduced in the area of the parting lines, where the portions of material are cut off after introduction of the grooves. This area is machined anyway by the subsequent edge machining of the material portion, such that any deformation in the edge area may be eliminated.

A wedge-shaped groove is preferably stamped in as the compensating stamping, the tip of which wedge points towards the opposite side of the strip, where the groove is stamped in.

Strip curvature may also be dealt with if the follow-on tool for the cutting-off of material portionsis appropriately adapted. The stamping-in of compensating grooves may be dispensed with in this case.

Exemplary embodiments of the invention are explained in more detail below with reference to the drawings, in which:

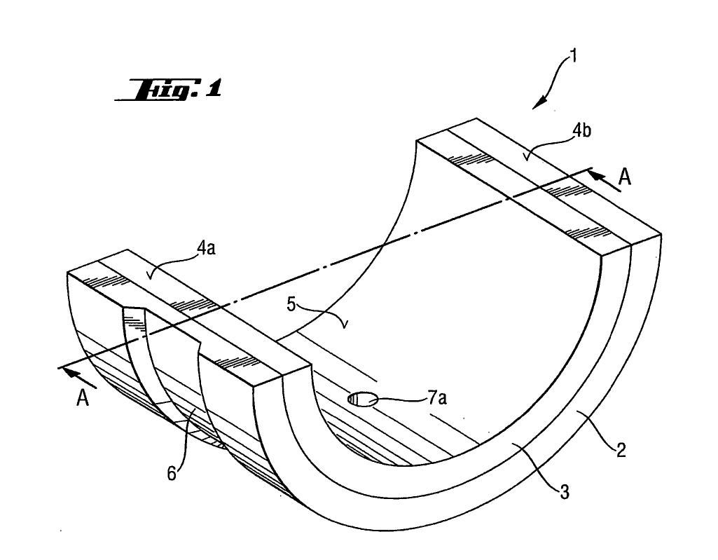

FIG. 1 is a perspective representation of a bearing shell,

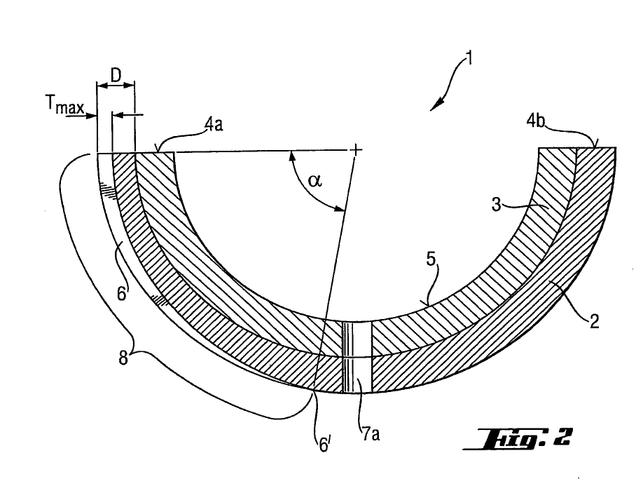

FIG. 2 shows a section along line A-A through the bearing shell shown in FIG. 1,

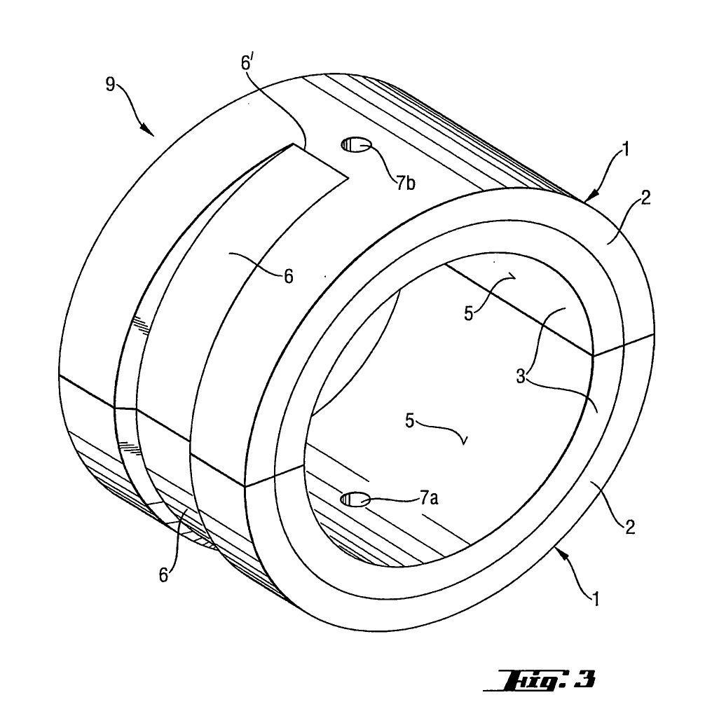

FIG. 3 is a perspective representation of a bearing consisting of two bearing shells,

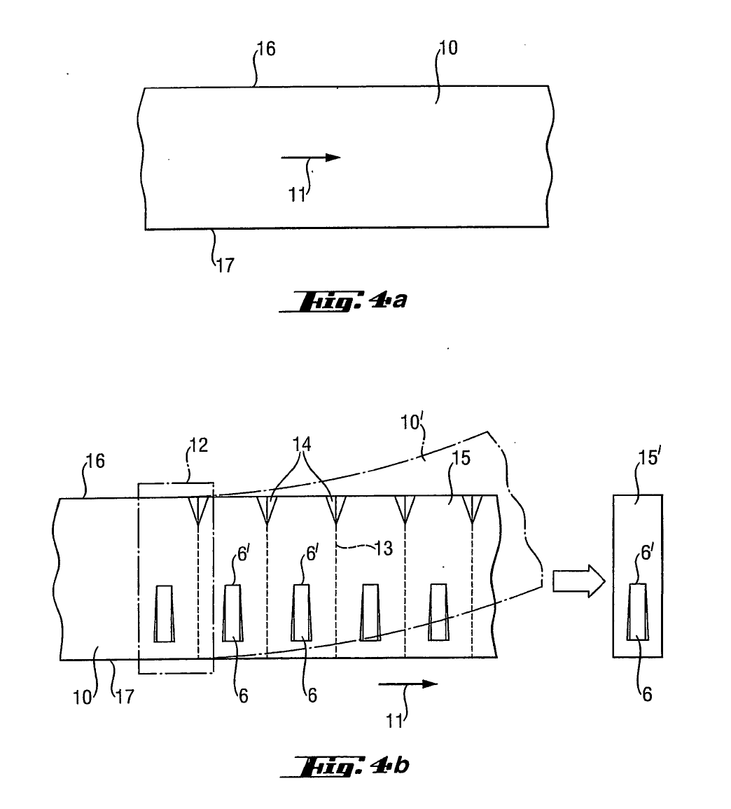

FIGS. 4a and 4b show plan views of a material strip for strip machining according to a first embodiment.

FIG. 1 is a perspective representation of a bearing shell 1, comprising a metallic backing material 2, steel in this case, which is coated with a plain bearing material 3 forming the sliding surface 5. The two upper end faces of the bearing shell 1 are designated parting faces 4a, 4b. Starting from the parting face 4a, a groove 6 extends over a part 8 of the outer circumference of the bearing shell 1. The groove 6 is stamped into the backing material 2 and, as is visible in the area of the parting face 4a, has a trapezoidal cross-section (c.f. also FIGS. 2 and 3). In the area of the parting face 4a, the depth of the groove 6 is at its maximum, said depth reducing along the groove such that the groove 6 is discontinued at its end 6′ and merges with the surface of the backing material 2. The groove 6 extends parallel to the axial end faces of the bearing shell.

FIG. 2 shows a section along line A-A of the bearing shell 1 shown in FIG. 1. The groove 6 extends over a circumferential angle 8 of the outer circumference of the bearing shell 1 The maximum depth Tₘₐₓ of the groove 6 is reached in the area of the parting face 4a, where the groove 6 opens into the parting face 4a. The depth T reduces continuously over the circumferential angle 8, which amounts in the embodiment illustrated here to approx. 80°. The maximum depth Tₘₐₓ amounts in the embodiment illustrated here to approximately 0.4·D, wherein D designates the thickness of the backing material. The bearing shell illustrated in FIG. 2 also additionally comprises an oil hole 7a at the vertex of the bearing shell.

FIG. 3 is a perspective representation of a bearing 9 consisting of two bearing shells 1. The two bearing shells 1 are arranged in such a way that the two grooves 6 of the upper and lower bearing shells 1 merge with one another and thus form a common groove.

FIG. 4a is a plan view of a material strip 10, which consists of a backing material 2 coated with plain bearing material 3 and which is moved in the feed direction 11. The material strip 10 here is straight, with its two edges 16, 17 oriented parallel to one another.

Such a material strip 10, which comprises the composite consisting of backing material 2 and plain bearing material 3, is fed to a stamping station 12, as indicated schematically in FIG. 4b.

A groove 6 extending perpendicular to the direction of feed 11 is stamped in in the stamping station 12, wherein a compensating stamping 14 is also introduced in the form of a wedge-shaped groove in the area of the parting line 13. The parting line 13 denotes the line at which the portion 15 of material is cut off in a subsequent operation. The cut-off material portion 15′ forms an intermediate product, which is shaped into the finished bearing shell 1.

The compensating stamping 14 is wedge-shaped, such that the greatest material displacement occurs at the edge 16 of the strip 10. If these compensating stampings 14 were to be dispensed with, the strip 10 would buckle and, after the stamping-in of a plurality of grooves 6, would assume the curved shape indicated with a dash-dotted line and labeled with reference numeral 10′.

The compensating stampings 14 make it possible to keep the edges 16 and 17 of the strip 10a parallel, despite stamping-in of the grooves 6. Care should be taken in this respect to ensure that the maximum width of the wedge-shaped grooves 14 corresponds roughly to the width of the grooves 6.

### REFERENCE NUMERALS

1 Bearing shell
2 Backing material
3 Plain bearing material
4a, b Parting face
5 Sliding surface
6 Groove
6′ Groove end
7a, b Oil hole
8 Circumferential angle
9 Bearing
10 Strip
10′ Strip
11 Direction of feed
12 Stamping station
13 Parting line
14 Compensating stamping
15, 15′ Portions of material
16 Edge
17 Edge

1. A bearing shell comprising:
a backing material of metal which is coated at least with a plain bearing material, and including at least one oil-conveying groove stamped into the rear of the backing material.

2. A bearing shell according to claim 1, wherein the groove extends from a bearing shell end over a part of the outer circumference of the bearing shell.

3. A bearing shell according to claim 1, wherein the groove extends in the circumferential direction.

4. A bearing shell according to claim 1, wherein the groove opens into a parting face of the bearing shell.

5. A bearing shell according to claim 1, wherein the groove extends over a circumferential angle of ≦120°.

6. A bearing shell according to claim 5, wherein the groove extends over a circumferential angle of ≦90°.

7. A bearing shell according to claim 1, wherein the groove has a maximum depth Tₘₐₓ in the area of a parting face and where depth T reduces continuously along the groove until T=0.

8. A bearing shell according to claim 7, wherein the depth Tₘₐₓ is ≦0.8 D, where D is the thickness of the backing material.

9. A bearing shell according to claim 1, wherein the plain bearing material is selected from a group consisting essentially of an Al alloy and a sintered bronze.

10. A bearing having two bearing shells each comprising a backing material of metal which is coated at least with a plain bearing material and including at least one oil-conveying groove stamped into the rear of the backing material wherein the two bearings shells are arranged in such a way that parting faces of the two bearing shells into which the grooves open lie against one another.

11. (canceled)

12. A method of producing baring shells, comprising:
preparing of a strip of composite material by coating one side of a metallic backing material with at least one plain bearing material,
stamping grooves into the bare backing material of the strip,
cutting off of portions of material,
shaping the cut portions of material into bearing shells, and
internal machining of the bearing shells to remove material.

13. A method according to claim 12, wherein the grooves are stamped perpendicular to a direction of feed of the strip.

14. A method according to claim 13, wherein the grooves are stamped with a continuously reducing groove depth T.

15. A method according to claim 12, wherein a surplus of the plain bearing material is applied to the backing material and in that the bearing material is thereafter reduced to its final thickness during the internal machining of the bearing shell.

16. A method according to claim 12, wherein at least one compensating stamping is made on the opposite side of the strip from the groove.

17. A method according to claim 16, wherein the compensating stamping is made in the area of the parting line.

18. A method according to claim 16 wherein a wedge-shaped groove is stamped in as the compensating stamping.
